(19) United States
(12) Patent Application Publication
(10) Pub. No.: US 2004/0173432 A1
(43) Pub. Date: Sep. 9, 2004

(54) Compact currency bill and coin processing device

(76) Inventor: William J. Jones, Barrington, IL (US)

Correspondence Address: CUMMINS-ALLISON CORP., C/O JENKENS & GILCHRIST, 225 WEST WASHINGTON STREET, SUITE 2600, CHICAGO, IL, 60606, US

(21) Appl. No.: 10/782,447

(22) Filed: Feb. 19, 2004

Related U.S. Application Data
(60) Provisional application No. 60/452,301, filed on Mar. 5, 2003.

(51) Int. Cl. G06F 7/00; G06F 9/00; G07F 9/08; G06F 19/00

(52) U.S. Cl. 194/216

(57) ABSTRACT

A cash processing system for processing currency bills and coins comprises a compact housing, a currency bill processing device that is disposed within the compact housing for determining the value of a batch of currency bills, a coin processing device that is disposed within the compact housing for determining the value of a batch of coins, and a central processing unit that is disposed within the compact housing. The central processing unit controls the operation of the currency bill processing device and the coin processing device and determines a total value of currency bills and coins processed.

### CROSS-REFERENCE TO RELATED APPLICATION

This application claims the benefit of U.S. Provisional Patent Application No. 60/452,301, entitled “Compact Currency Bill and Coin Processing Device,” which was filed on Mar. 5, 2003 and is incorporated herein by reference in its entirety.

### FIELD OF THE INVENTION

The present invention relates generally to the field of cash handling systems and, more particularly, to a system for processing currency bills and coins in a single processing device.

### BACKGROUND OF THE INVENTION

Currency bill and coin processing machines have been used for a number of years. These machines range from large floor systems to desktop units. In some applications, however, space is at such a premium that even the desktop units consume too much space for the end user. This problem is further exacerbated by having two units—one for currency bills and one for coins. In small retail stores, including fast food outlets, the space required for dedicated units takes away valuable space that could be used for display, inventory or, in the case of the fast food outlet, food preparation. Thus, there exists a need for a compact device that processes both currency bills and coins.

### SUMMARY OF THE INVENTION

A cash processing system for processing currency bills and coins comprises a compact housing, a currency bill processing device that is disposed within the compact housing for determining the value of a batch of currency bills, a coin processing device that is disposed within the compact housing for determining the value of a batch of coins, and a central processing unit that is disposed within the compact housing. The central processing unit controls the operation of the currency bill processing device and the coin processing device and determines a total value of currency bills and coins processed.

The above summary of the present invention is not intended to represent each embodiment, or every aspect, of the present invention. This is the purpose of the figures and the detailed description, which follows.

### BRIEF DESCRIPTION OF THE DRAWINGS

FIG. 1 is a functional block diagram of a compact currency bill and coin processing system according to one embodiment of the present invention.

FIG. 2 is a perspective view of a compact cash processing system according to another embodiment of the present invention.

FIG. 3 is a functional block diagram of a currency bill processing device for use in the compact cash processing system of FIG. 2.

FIG. 4 is a functional block diagram of the coin processing device for use in the compact cash processing system of FIG. 2.

FIG. 5 illustrates a cash till manifold for use with the cash processing system of FIG. 2 according to one embodiment of the present invention.

FIG. 6 is a perspective view of the compact cash processing system of FIG. 2 in use with the manifold of FIG. 5.

FIGS. 7a and 7b illustrate an alternative manifold that allows for coin bags to be attached to the manifold structure according to one embodiment of the present invention.

FIG. 8 is a flow chart illustrating the operation of the currency bill processing device of FIG. 2 according to one embodiment of the present invention.

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF THE SPECIFIC EMBODIMENTS

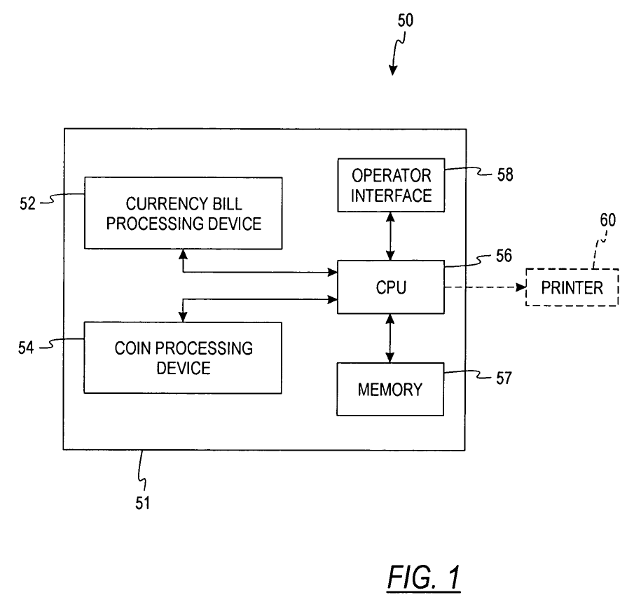

Referring now to FIG. 1, a functional block diagram of a compact cash processing system 50 disposed within a compact housing 51 is shown according to one embodiment of the present invention. One use of the compact cash processing system 50 is to total currency bills and coins in a batch such as, for example, a cash till drawer at a bank or retail store. The compact cash processing system 50 includes a device 52 for processing currency bills and a device 54 for processing coins.

The currency bill processing device 52 is capable of authenticating currency bills, denominating currency bills, or a combination thereof. The coin processing device 54 is capable of sorting coins by denomination, counting coins, authenticating coins, or a combination thereof.

The compact cash processing system 50 includes a processor such as a central processing unit (CPU) 56 for controlling the operation of the currency bill processing device 52 and the coin processing device 54. The CPU 56 is linked to a memory 57 for storing information such as currency bill processing results, coin counts and totals as well as master authenticating characteristic information for use in authenticating currency bills, master denominating characteristic information for use in denominating currency bills, and the algorithms necessary for calculating coin and currency bill totals within the respective units.

The compact cash processing system 50 includes an operator interface 58 communicatively linked to the CPU 56 for receiving input from and displaying information to an operator of the system 50. The operator interface 58 may comprise an LCD display and a keypad or a touch-screen according to alternative embodiments of the present invention. In another alternative embodiment, the compact cash processing system 50 is controlled by an external personal computer that is linked to the system 50.

According to one embodiment, the compact cash processing system 50 is linked to an optional printer 60 for providing the operator with a hardcopy of totals and results of the processing of currency bills and/or coins with the system 50. According to another alternative embodiment, the printer is an integral part of the compact cash processing system 50.

While the compact cash processing system 50 is discussed herein as including a currency bill processing device 52, the currency bill processing device 52 can be adapted to process other types of documents including, for example, checks, coupons, deposit slips, casino tickets, etc. in alternative embodiments of the present invention. For example, according to one embodiment of the present invention, the currency bill processing device is capable of imaging documents for obtaining images of each of the documents, including currency bills, processed. During processing, the images of the processed documents are stored and used to verify receipt of documents, subsequent deposits, etc. According to one embodiment of the present invention, the cash processing system 50 is communicatively linked to a network (e.g., the network of the institution where the system 50 is located) for transmitting the images to the network and/or other devices and systems linked to the network. For example, the images may be sent to a bank or other financial institution for deposit. Document processing devices capable of obtaining images of documents and processing currency bills and other documents for use with the present invention are described in U.S. patent application Ser. No. 60/413,387 (filed Sep. 25, 2002); U.S. Patent Application Publication No. 2002/0085745; U.S. Pat. No. 6,363,164; and PCT International Application Publication No. WO 98/47100; each of which is incorporated herein by reference in its entirety.

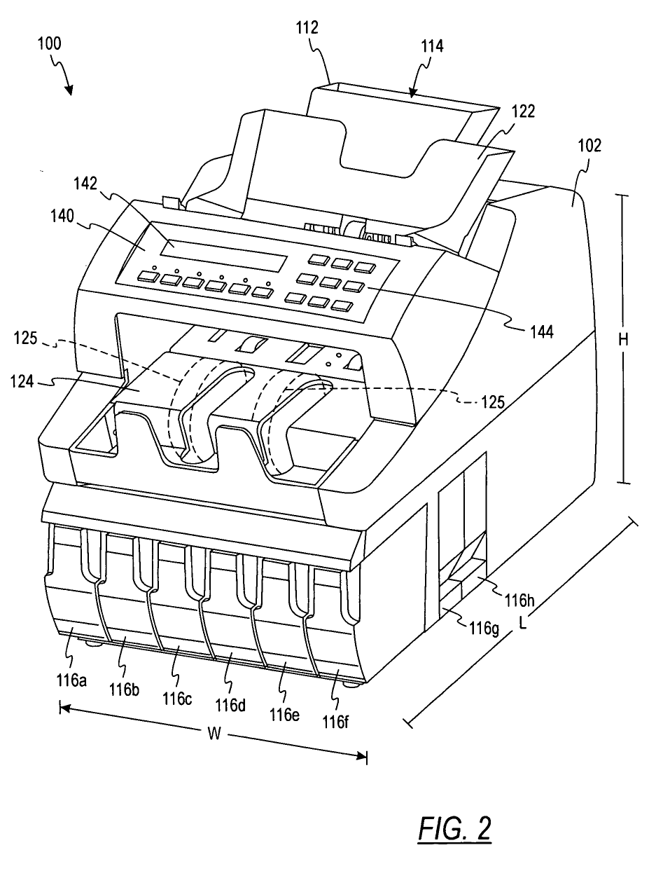

Referring now to FIG. 2, a compact cash processing system 100 according to one embodiment of the present invention is shown. According to the illustrated embodiment, the currency bill and coin processing devices are mechanically distinct machines within the compact cash processing system 100 sharing a common compact housing 102, power supply, CPU, and the operator interface 140.

For processing coins, the compact cash processing system 100 includes a coin hopper 112 that receives coins of mixed denominations and feeds the coins through a central funnel 114 under the force of gravity. As is explained in detail below, the coins are sorted into a plurality of coin bins 116a-h positioned on the exterior of the compact cash processing system 100.

For processing currency bills, the compact cash processing system 100 includes an input receptacle 122 and a single output receptacle 124. Currency bills are fed, one by one, from a stack of documents placed in an input receptacle 122, and transported past an evaluation region into an output receptacle 124. In another embodiment, the compact cash processing system 100 includes a second output receptacle. The cash processing system 100 includes a pair or stacking wheels 125 for stacking currency bills in the output receptacle 124.

An operator interface 140 is used by the operator to control the compact cash processing system 100. The operator interface 140 includes a display 142 for displaying information about the compact cash processing system 100. The operator interface 140 also includes keys 144 allowing the operator to input information to the compact cash processing system 100. According to an alternative embodiment, the keys 144 are part of a remote or wireless keyboard. According to an alternative embodiment, the operator interface 140 may also include a touch screen device, the features of which are programmable and thus provide more versatility to the operator when interacting with the compact cash processing system 100. In embodiments wherein the compact cash processing system 100 is capable of imaging documents, the document images may be displayed on the screen of the operator interface 140.

The compact cash processing system 100 is disposed within a compact housing 102 that is small enough to be placed on a tabletop. The compact cash processing system 100 has a depth D and a width W. In one embodiment, the depth D is about 16 inches and the width is approximately 10.5 inches. When the front coin bins 116 are extended, the effective depth D′ of the compact sorter is about 20 inches. Thus, the compact cash processing system 100 has a footprint that is roughly 170 square inches when the coin bins 116 are extended. The effective footprint (D′×W) is the counter space that is needed to operate the compact cash processing system 100 with six coin bins (e.g., the U.S. coin set) since opening and closing the coin bins 116 are functions that the operator performs when using the coin bins 116. The height H of the compact cash processing system 100 is approximately 14 inches, which translates to a volume of about 2350 in³ when the coin bins 116 are closed and a volume less than about 3000 in³ when the coin bins 166 are extended for accessing the sorted coins.

In other alternative embodiments, the cash processing system 100 has a width W of about 11 inches, a depth D of about 17 inches (and an effective depth D′ of about 21 inches), and a height H of about 19 inches. In this embodiment, the coin sorting system occupies a footprint of about 187 in² (less than about 230 in² with the coin bins 116 extended) and a volume of about 3553 in³ (less than about 4400 in³ with the coin bins 116 extended).

In another alternate embodiment of the present invention wherein the currency processing device of the compact cash processing system has two output receptacles, the compact cash processing system has a width W of about 11 inches, a depth D of about 17 inches (and an effective depth D′ of about 21 inches), and a height H of about 25 inches. In this embodiment, the coin sorting system occupies a footprint of about 187 in² (less than about 230 in² with the coin bins 116 extended) and a volume of about 4675 in³ (less than about 5780 in³ with the coin bins 116 extended).

If the compact cash processing system 100 is to be used for sorting only six coin denominations (e.g., when processing the U.S. coin set), then only the six coin bins 116a-f located on the front of the compact cash processing system 100 are used. Alternatively, if the compact cash processing system 100 is to be used for sorting eight denominations, then two additional coin bins 116g,h can be placed along the side of the compact cash processing system 100. Alternatively, the coin bins 116 may be removed entirely from the compact cash processing system 100 such that a tray, a cash register till, or coin bags receive the processed coins. In alternative embodiments of the present invention, the compact cash processing system 100 can be adapted to sort more than eight denominations of coins at a time.

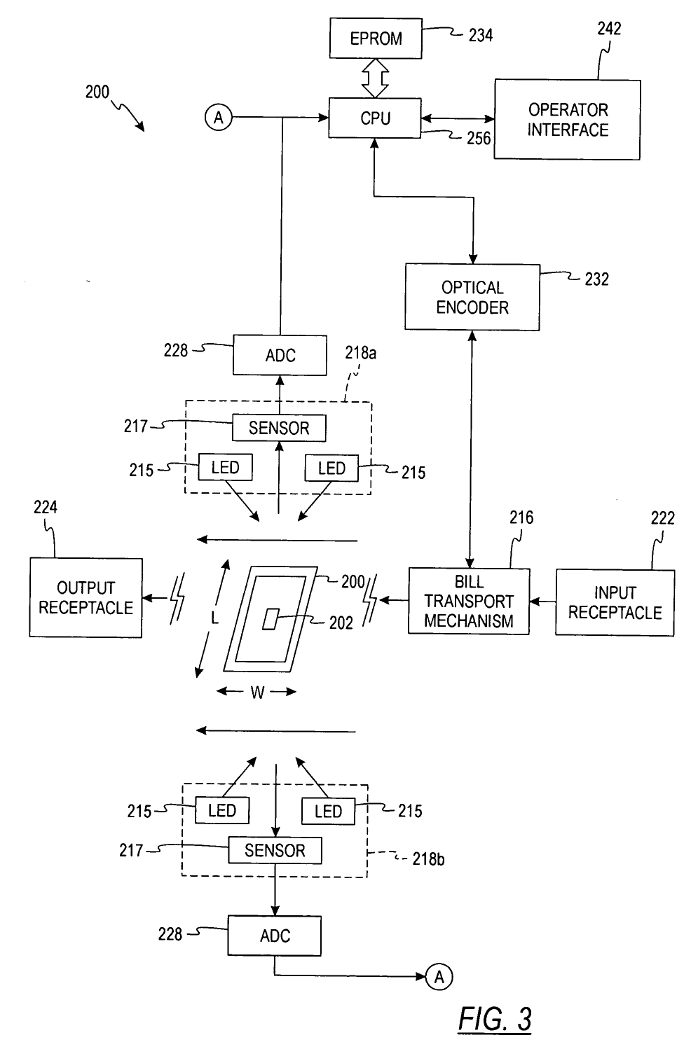

Referring now to FIG. 3, a currency bill processing device 200 for use as the bill processing device 52 (FIG. 1) of the compact cash processing system 100 is functionally illustrated. The currency bill processing device 200 of FIG. 3 has a single output receptacle 224 and is referred to as a “single-pocket device.” Currency bills to be processed are stacked in the input receptacle 222 and are picked out or separated, one at a time, and sequentially transported by a currency bill transport mechanism 216, between a pair of scanheads 218a,b where, for example, the currency denomination of the currency bill is scanned and identified. In the embodiment depicted, each scanhead 218a,b is an optical scanhead that scans for characteristic information from a currency bill 200 that is used to identify the denomination of the currency bill. The scanned currency bill 200 is then transported to an output receptacle 224 where currency bills so processed are stacked for subsequent removal.

Additionally, in embodiments of the system 100 wherein the bill processing device 52 is capable of imaging and processing documents, the characteristic information may be obtained from an image of the bills and compared to master information stored in memory. Documents such as checks can be imaged in such an embodiment for the purpose of value assignment and storage of the document.

The operator interface 242 receives input from and displays information to an operator of the compact cash processing system 100. Input data may comprise, for example, operator-selected operating modes and operator-defined operating parameters for the compact cash processing system 100. Output data displayed to the user may comprise, for example, a selection of operating modes and/or information relevant to the status of currency bills being processed by the compact cash processing system 100.

In alternative embodiments of the present invention, additional sensors can replace or be used in connection with the optical scanheads 218a,b in the single-pocket device 100 to analyze, authenticate, denominate, count, and/or otherwise process currency bills. For example, size detection sensors, magnetic sensors, thread sensors, and/or ultraviolet/fluorescent light sensors may be used in the currency bill processing device 52 to evaluate currency bills. The use of these types of sensors for currency evaluation are described in commonly owned U.S. Pat. No. 6,278,795, which is incorporated herein by reference in its entirety.

According to one embodiment of the currency bill processing device 52, each optical scanhead 218a,b comprises a pair of light sources 215 that directs light onto the currency bill transport path so as to illuminate a substantially rectangular light strip 202 upon a currency bill 200 positioned on the transport path adjacent the scanhead 218. Light reflected off the illuminated strip 202 is sensed by a photo detector 217 positioned between the two light sources. The analog output of the photo detector 217 is converted into a digital signal by means of an analog-to-digital converter (ADC) 228 whose output is fed as a digital input to a processor such as the CPU 256.

According to one embodiment, the currency bill transport path is defined in such a way that the transport mechanism 216 moves currency bills with the narrow dimension of the currency bills being parallel to the transport path and the scan direction. Put another way, the wide edge of a currency bill is the leading edge of the currency bill. As a currency bill 200 traverses the scanheads 218a,b, the light strip 202 effectively scans the currency bill across the narrow dimension of the currency bill. In the embodiment depicted, the transport path is so arranged that a currency bill 200 is scanned across a central section of the currency bill along its narrow dimension, as shown in FIG. 3. Each scanhead 218a,b functions to detect light reflected from the currency bill 20 as it moves across the illuminated light strip 202 and to provide an analog representation of the variation in reflected light, which, in turn, represents the variation in the dark and light content of the printed pattern or indicia on the surface of the currency bill 200. This variation in light reflected from the narrow dimension scanning of the currency bills serves as a measure for distinguishing, with a high degree of confidence, among a plurality of currency denominations which the system is programmed to handle. While the transport mechanism 216 is shown and described as transporting bills such that a bill's wide edge is the leading edge, the transport mechanism may transport bills such that a bill's narrow edge is the leading edge in alternative embodiments of the present invention.

Additional details of the mechanical and operational aspects of the currency bill processing device are described in detail in U.S. Pat. Nos. 5,295,196 and 5,815,592, each of which is incorporated herein by reference in its entirety. According to various alternative embodiments, the compact cash processing system 100 is capable of processing, including denominating the currency bills, from about 800 to over 1500 currency bills per minute.

While the currency bill processing device 52 has been described as determining the denomination of processed currency bills, the compact cash processing system 100 may only count bills according to an alternative embodiment of the present invention. Counting differs from denominating in that currency bill counters do not denominate the currency bills being processed and are not designed to process and determine the total value of a stack of mixed denomination currency bills. Currency bill counters are disclosed in commonly owned U.S. Pat. Nos. 6,026,175 and 6,012,565, each of which is incorporated herein by reference in its entirety.

While the currency bill device 52 of the cash processing system 100 has been described as a single-pocket device, a currency bill process device having a plurality of output receptacles (e.g., a two-pocket device) may be used in connection with the cash processing system 100 in alternative embodiments of the present invention. A currency processing device having two output receptacles that may be used in connection with the cash processing system in alternative embodiments of the present invention is described in U.S. Pat. No. 6,311,819, which is hereby incorporated by reference in its entirety.

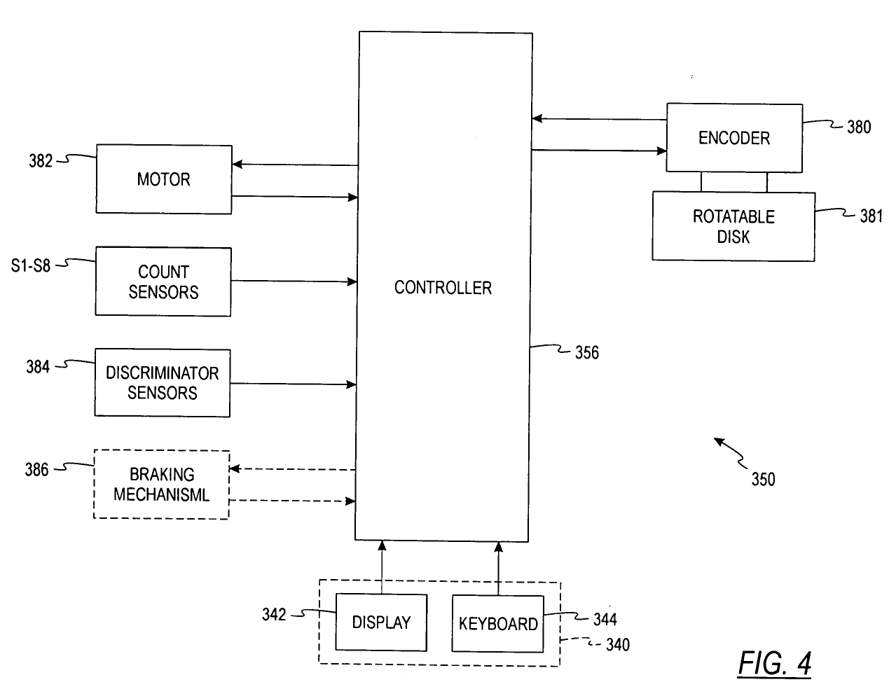

Referring to FIG. 4, a coin sorting and counting device 350 that can be used as the coin processing device 54 (FIG. 1) of the compact cash processing system 100 is functionally illustrated. The coin processing device 350 includes a coin hopper 112 that receives coins of mixed denominations and feeds them into an opening in an annular sorting funnel 114 positioned below the coin hopper 112. As the coins pass through the central annular sorting funnel 114, they are deposited on top of a rotatable disk 381 as fully described in U.S. Pat. No. 5,997,395, which is incorporated herein by reference in its entirety.

A sorting head of the coin processing device 54 includes a plurality of shaped regions for directing the movement of the coins and sorting the coins by diameter and discharging the sorted coins out of a plurality of exit channels. The sorted coins are captured in the plurality of coin bins 116 positioned on the exterior of the compact cash processing system 100. If the coin processing device 54 is to be used for sorting only six denominations (like in the U.S. coin set), then only the six coin bins 116a-f located on the front of the compact cash processing system 100 are used. Alternatively, if the coin sorter device 54 is to be used for sorting eight coin denominations, then two additional coin bins 116g-h are placed along the side of the compact cash processing system 100. In yet other alternative embodiments of the present invention, the compact cash processing system 100 is adapted to process more than eight coin denominations.

A system controller 356 can serve as the CPU 56 (FIG. 1) of the compact cash processing system 100. The operator communicates with the coin sorter device 54 via the operator interface 340 by allowing the operator to input information via the keyboard 344. The display 342 of the operator interface 340 informs the operator about the function and operation of the coin sorter device 350.

The controller 356 receives signals from an encoder 380, which monitors the movement of the rotatable disk 381. The encoder 380 includes a disk attached to the rotatable disk 381 that includes numerous uniformly spaced indicia along its circular periphery, which an encoder sensor detects. Because the encoder's 380 disk is fixed to the rotatable disk 381 as described in Pat. No. 5,997,395, it rotates at the same rate as the rotatable disk 381. As the encoder 380 disk rotates, the indicia are detected by an encoder sensor and the controller 356 knows the angular velocity at which the rotatable disk 381 is rotating. The controller 356 monitors the change in the angular velocity, that is the acceleration and deceleration, as well. In an alternative embodiment, the encoder system can be of a type commonly known as a dual channel encoder in which two encoder sensors are used. The signals, which are produced by the two encoder sensors and detected by the controller 356, are generally out of phase. The direction of movement of the rotatable disk 381 can be monitored by utilizing the dual channel encoder.

The controller 356 also controls the power supplied to the motor 382, which drives the rotatable disk 381. Because it is often necessary to know whether the motor 382 is operational, the controller 356 detects whether power is being supplied to the motor 382. Typically, a current sensor accomplishes this, which senses the amount of current being supplied to the motor. When the motor 382 is a DC motor, the controller 356 can reverse the current to the motor 382 to cause the rotatable sorting disk 381 to decelerate. Thus the controller 356 can control the speed of the sorting disk 381 without the need for a mechanical braking mechanism.

Still in reference to FIG. 4, the controller 356 also monitors the counting sensors S1-S8, which are stationed adjacent to the exit channels of the sorting head. As coins move past one of these counting sensors S1-S8, the controller 356 receives the signal from the counting sensor for the particular denomination of the passing coin and adds one to the counter for that particular denomination within the controller 356. The controller 356 has a counter for each denomination of coin that is to be sorted. In this way, each denomination of coin being sorted by the coin sorter has a count continuously tallied and updated by the controller 356.

If an optional braking mechanism is used, the controller 356 also controls the mechanical braking mechanism. Because the amount of power applied is proportional to the braking force, the controller 356 has the ability to alter the deceleration of the sorting disk 381 by varying the power applied to the braking mechanism. Further details of the mechanical and operation aspects of a coin sorting device for use with the cash processing system 100 is disclosed in U.S. Pat. No. 5,997,395, which is incorporated herein by reference in its entirety.

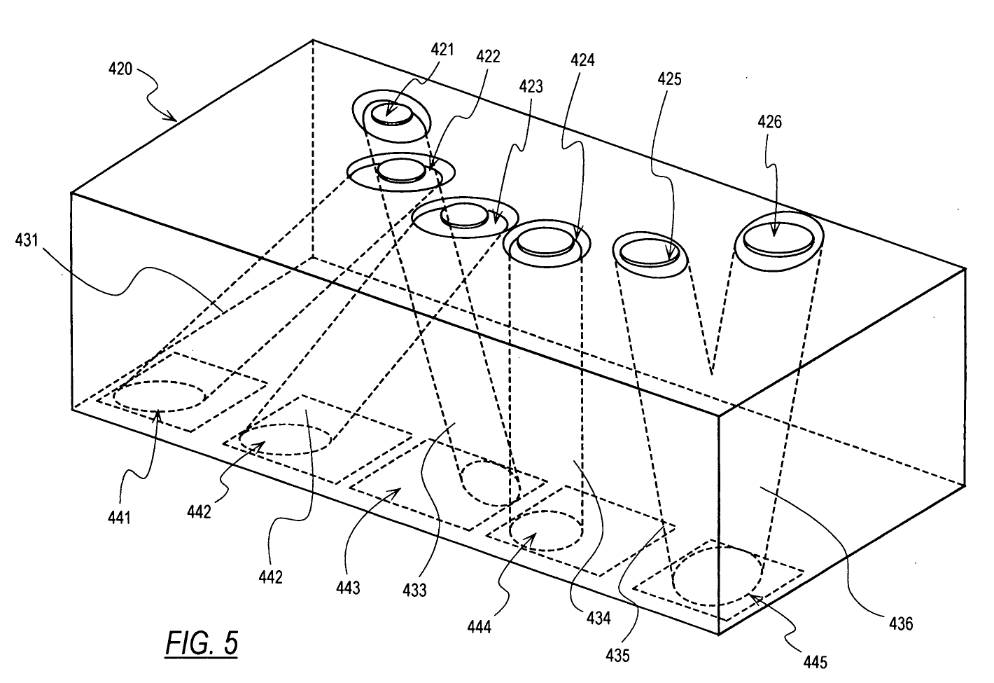

Referring now to FIG. 5, the operator of the compact cash processing system 100 may decide that the coin bins 116 are not needed and, instead, the sorted coins must be directed into the cash till of a typical cash register. Because the coins are sorted based on their diameters—not on their value—according to one embodiment of the present invention, it is necessary to distribute the sorted coins into a pattern that coincides with the coin receptacle locations in a cash till of a cash register. A typical cash register has coin receptacles in which coins are placed in the order of increasing value. Most cash register cash tills use just one coin receptacle for both half-dollar and dollar coins because they are used infrequently. Thus, the standard U.S. cash till has only five coin receptacles. To convert the compact cash processing system 100 into a system that directs coins into a cash till of a standard retail cash register, the compact cash processing system 100 may include a manifold 420 as shown in FIG. 5.

The manifold 420 includes six inlets 421-426 that receive coins in the order of increasing diameters of the coins. Put another way, when the manifold 420 is used with the United States coin set, the inlet first 421 receives dimes, the second inlet 422 receives pennies, the third inlet 423 receives nickels, the fourth inlet 424 receives quarters, the fifth inlet 425 receives dollars, and the sixth inlet 426 receives half-dollars. But to place these coins in ascending value in a coin till, it is necessary to rearrange the flow of these coins along their respective coin paths. Accordingly, from the inlets 421-426, the coins travel down particular coin paths 431-436, which lead only to five outlets 441-445. Consequently, the dimes, which enter the first inlet 421, move down path 433 to the third outlet 443. Pennies enter the second inlet 422 and move along path 431 to the first outlet 441. Nickels enter the third inlet 423 and move down path 432 to the second outlet 442. Quarters enter the fourth inlet 424, move through path 434 and exit through the fourth outlet 444. Dollars and half-dollars enter the fifth inlet 425 and the sixth inlet 426, respectively, and move through paths 435 and 436, respectively, and enter into the fifth outlet 445.

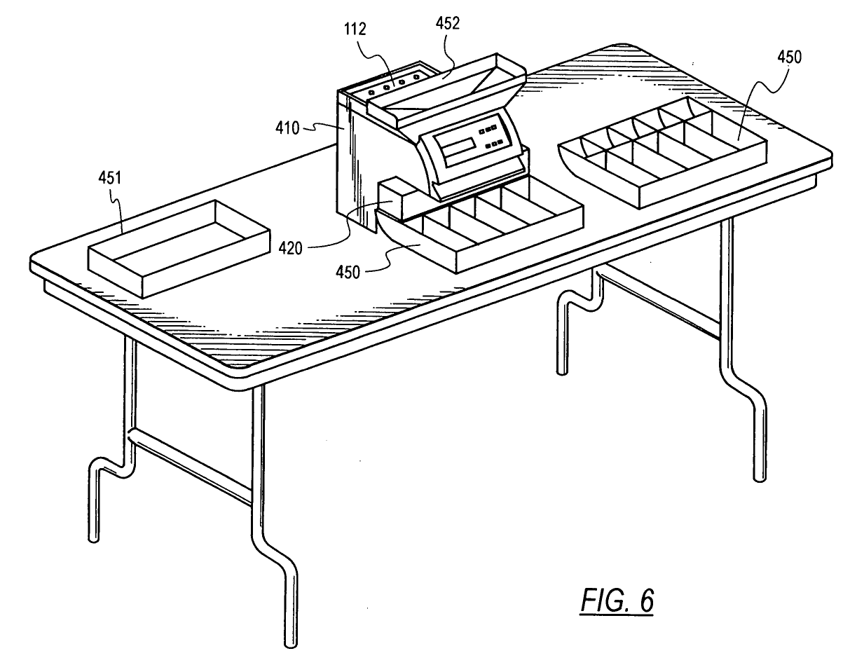

Referring to FIG. 6, once the manifold 420 is attached to the coin sorting device 410, a cash till 450 is inserted under the manifold 420. The operator of the system then places the coins that are desired to be distributed into the till 450 into the coin hopper 112 of the compact cash processing system 100. The operator then activates the compact cash processing system 100 and the coins are sorted and distributed into the till 450. This results in a very efficient procedure by which a retail cashier, for example, places the entire day's worth of coins into the coin hopper 112, instructs the compact cash processing system 100 to begin sorting (which returns the coins to the till), and reads the value of the counted coins from the display 58 of the compact cash processing system 100 to assist the cashier in verifying the amounts received in the cashier's till during the day. This saves the cashier from having to manually count each of the coins present in the till. Likewise, the use of the compact cash processing system 100 with the manifold 420 is also helpful at the beginning of the day when a cashier takes a given amount of money in currency and coins to the cash register and must determine the initial starting amount present in the cash till 450.

Because the compact cash processing system 100 has a width that is less than the typical cash till 450, the compact cash processing system 100 may include a conversion device 452 over the coin hopper 112. The conversion device 452 is wide enough to allow the cashier to insert the cashier's cash till 450 and dump the coins from till 450 into the compact cash processing system 100 for processing without having to worry about the coins being spilled onto the floor. The conversion device 452 funnels the coins into a lower aperture that corresponds in size to the coin hopper 112. An alternative collection device to both the coin bins 116 and the cash till 450, is a cash tray 451. The tray 451 can be used for the bulk collection of coins in applications where the coins need to be counted and tallied but not sorted.

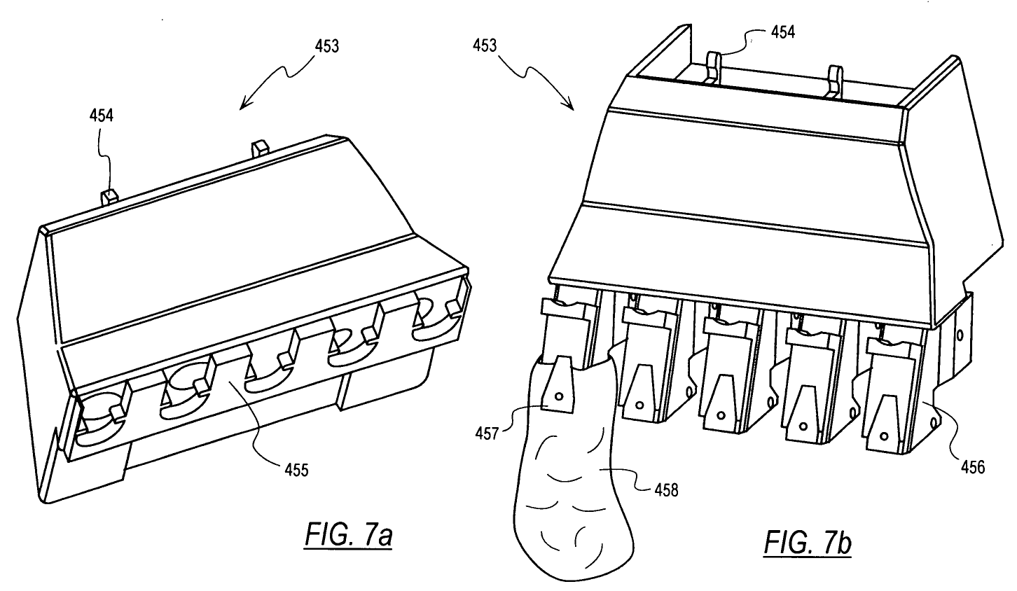

FIGS. 7a and 7b illustrate an alternative embodiment of a manifold 453 that can be used to distribute coins into a cash till 450 as shown in FIG. 6 or can be used to transfer coins into coin bags which are attached to the manifold 453. Adjacent to the coin inlets on the top surface of the manifold 453 are fasteners 454 which secure the manifold 453 to the compact cash processing system 100. At the lower end of the manifold 453, a mount section 455 receives the bag clamping mechanisms 456. The mount section 455 includes structures that allow the bag clamping mechanisms 456 to be inserted and removed with ease. For example, the mount section 455 may include a grooved region that receives a corresponding tongue on the bag clamping mechanism 456. The outlets for the coins are aligned with the bag clamping mechanism 456 when they are attached to the mount section 455. The bag clamping mechanism 456 includes a clip device 457, which holds the bag 458 in the appropriate position.

Because the standard U.S. cash till 450 has only five coin receptacles, the manifold 453 distributes the coins into five bags 457. However, the manifold 453 can be equipped with six inlets and six outlets (as opposed to the six inlets 421-426 and five outlets 441-445 in FIG. 5) to distribute coins into six bags. A diverting mechanism would be placed in the coin paths for the dollar coins and half-dollar coins. When the diverter is not in use, the half dollar coins and dollar coins flow into separate outlets. But when the operator implements the diverting mechanism, the flow of the half dollar coins are directed toward the same outlet as the dollar coins. Thus, the operator dictates when the dollar coins and half dollar coins are separated (e.g., when the bags 458 are in use) or combined (e.g., when the cash till 450 is in use). It should be noted that the compact cash processing system 100 should be placed on a platform when the bags 458 are in use to account for the size of the bags. In alternative embodiments of the present invention, the manifold can be adapted to process coins sets having more than six coins (e.g., seven, eight, or nine coins). In yet other alternative embodiments of the present invention, the manifold can be adapted to route coins for arrangement in a variety of fashions.

While the coin processing device 54 of the cash processing system 50 has been described thus far as a device that sorts coins according to denomination, the coin processing device 54 may be a device that only counts coins or counts and authenticates coins, and does not sort coins.

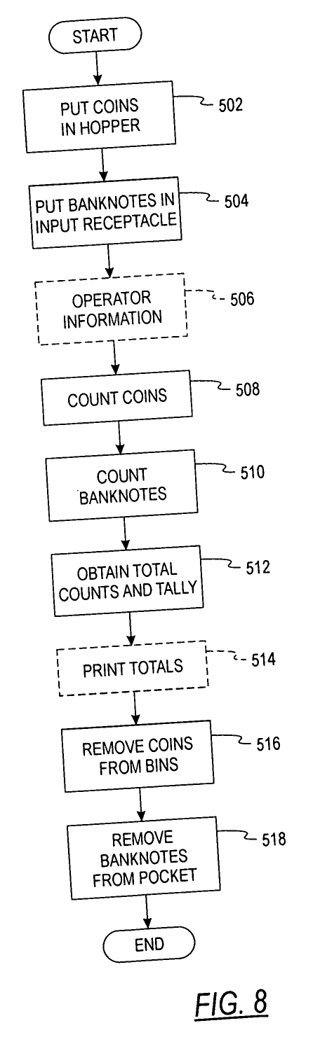

Referring now to FIG. 8, the operation of the compact cash processing system 100 will now be described according to one embodiment of the present invention. One application of the compact cash processing system 100 is in a retail setting (e.g., a grocery store or fast food restaurant) where cash transactions are commonplace. Typically in retail settings, cashiers operate a cash register that holds cash (coins and currency bills) in a cash till drawer. Coins and currency bills are segregated by denomination in separate compartments in the cash till drawer. At certain times during the day, such as at the end of a cashier's shift or at predetermined intervals, the cash till drawer of each cash register is “counted-down.” “Counting-down” is a process whereby cash in the cash till drawer is counted and then compared to the drawer's beginning balance and the day's sales/receipts. Counting-down a cash drawer is a time consuming process, and because the currency bills and coins are typically manually totaled, it is a process wrought with opportunity for human error.

A cashier charged with the task of counting down a cash till drawer can save time and reduce errors by using the compact cash processing system 100. The cashier begins, for example, by first emptying the till drawer of its contents; moving the coins to the coin hopper 114 at step 502 and placing the currency bills into the input tray 122 at step 504. According to an alternative embodiment, coin bags, a tray, or a cash till drawer may receive the sorted and counted coins instead of coin bins 116.

At step 506, the operator optionally inputs certain information via the operator interface 140 such as employee number, batch number, cash register, and/or station number, etc. This information may be included on a printout if an optional printer is used with the system 100. At step 508 the operator initiates the sorting and tallying of the coins, and at step 510 the operator initiates the counting and tallying of the currency bills. At step 510 the operator obtains the results of the tallying operation or operations. An optional printer prints the results at step 514. If a printer is not used, the operation may manually note the results or record them in a memory of the cash processing system 100. Alternatively, or additionally, if the compact cash processing system 100 is networked, the information may be transmitted to a processing unit connected for the purpose of obtaining and storing the tally information.

At step 516 the coins are removed from the coin bins 116 and replaced in the till drawer and the currency bills are removed at step 518, from the currency bill output receptacle 124 and sorted by hand into the till drawer. Alternatively, in another application, the bank notes and coins may be placed through another sorting process before restocking the till drawer with a set amount of cash.

While the invention is susceptible to various modifications and alternative forms, specific embodiments thereof have been shown by way of example in the drawings and herein described in detail. It should be understood, however, that it is not intended to limit the invention to the particular forms disclosed, but on the contrary, the intentions is to cover all modifications equivalents and alternatives falling within the spirit and scope of the invention as defined by the appended claims.

What is claimed is:

1. A cash processing system for processing currency bills and coins, the system comprising:
a compact housing;
a currency bill processing device disposed within the compact housing for determining the value of a batch of currency bills;
a coin processing device disposed within the compact housing for determining the value of a batch of coins; and
a central processing unit being disposed within the compact housing, the central processing unit being adapted to control the operation of the currency bill processing device and the coin processing device and to determine a total value of currency bills and coins processed.

2. The cash processing system of claim 1 wherein the compact housing is adapted to be placed on a table top.

3. The cash processing system of claim 1 wherein the compact housing has a width less than about 11 inches.

4. The cash processing system of claim 1 wherein the compact housing has a depth less than about 21 inches.

5. The cash processing system of claim 1 wherein the compact housing has a height less than about 19 inches.

6. The cash processing system of claim 1 wherein the compact housing occupies a footprint of less than about 230 square inches.

7. The cash processing system of claim 1 wherein the compact housing occupies a volume of less than about 4400 cubic inches.

8. The cash processing system of claim 1 wherein the currency bill processing device comprises:
an input receptacle adapted to receive a stack of currency bills to be processed;
an output receptacle adapted to received processed currency bills;
a transport mechanism adapted to transport currency bills, one at a time, from the input receptacle along a transport path to the output receptacle; and
an evaluation region disposed along the transport path adapted to determine information concerning each of the currency bills including a total amount of currency bills processed, the evaluation region being communicatively coupled to the central processing unit.

9. The cash processing system of claim 1 wherein the currency bill processing device is adapted to process bills at a rate greater than about 800 bills per minute.

10. The cash processing system of claim 1 further comprising an operator interface.

11. The cash processing system of claim 1 wherein the operator interface comprises a touch screen.

12. The cash processing system of claim 1 wherein the coin processing device comprises:
an input hopper for receiving coins of a plurality of denominations to be sorted;
a rotatable disk for imparting motion to the plurality of coins;
a stationary head having a lower surface generally parallel to and spaced slightly away from the rotatable disk, the lower surface having a plurality of shaped regions for controlling the movement of the coins and guiding coin to a plurality of exit channels for discharging coins, the plurality of coin exit channels corresponding to a plurality of coin denominations to be processed; and
a plurality of coin counting sensors for counting coins, one of the plurality of coin counting sensors being disposed at each of the plurality of exit channels.

13. The cash processing system of claim 12 wherein the plurality of coin counting sensors are communicatively coupled to the central processing unit.

14. The cash processing system of claim 13 wherein the coin processing device includes a discrimination sensor for discriminating between valid and invalid coins.

15. The cash processing system of claim 14 wherein the discrimination sensor is communicatively coupled to the central processing unit.

16. The cash processing system of claim 1 further comprising a printer for printing information regarding the processing of currency bills and coins.

17. A method of processing a batch of currency bills and coins with a compact cash processing device, the compact currency processing device being disposed within a compact housing adapted to be placed on a tabletop, the method comprising:
receiving a batch of currency bills and coins from an operator of the compact cash processing device;
determining the value of the received currency bills with a currency bill processing device disposed within the compact housing; and
determining the value of the received coins with a coin processing device disposed within the compact housing.

18. The method of claim 17 further comprising sorting the received coins with the coin processing device.

19. The method of claim 17 wherein the compact housing has a width less than about 11 inches.

20. The method of claim 17 wherein the compact housing has a depth less than about 21 inches.

21. The method of claim 17 wherein the compact housing has a height less than about 19 inches.

22. The method of claim 17 wherein the compact housing occupies a footprint of less than about 230 square inches.

23. The method of claim 17 wherein the compact housing occupies a volume of less than about 4400 cubic inches.

24. The method of claim 17 wherein determining the value of the received currency bills with a currency bill processing device comprises:
receiving the currency bills to be processed in an input receptacle of the currency bill processing device;
transporting currency bills, one at a time, from the input receptacle past an evaluation unit to an output receptacle;
determining information concerning each currency bill including the denomination of each currency bill with the evaluation unit.

25. The method of claim 17 wherein determining the value of the received currency bills with a currency bill processing device comprises determining the value of the received currency bills at a rate greater than about 800 bills per minute.

26. The method of claim 17 wherein determining the value of the received coins includes discriminating between valid and invalid coins.

27. The method of claim 17 further comprising printing information regarding the currency bills and coins processed by the compact currency processing device.
